(19) United States
(12) Patent Application Publication
(10) Pub. No.: US 2007/0212273 A1
(43) Pub. Date: Sep. 13, 2007

(54) Biotower eradicator

(75) Inventor: John Lee Edwards, Sarasota, FL (US)

Correspondence Address: Jackson Walker L.L.P.;c/o Mark A. Tidwell, Suite 1900, 1401 McKinney Street, Houston, TX, 77010, US

(73) Assignee: MicroSweep Corp., Sarasota, FL (US)

(21) Appl. No.: 11/642,075

(22) Filed: Dec. 20, 2006

Related U.S. Application Data
(60) Provisional application No. 60/751,547, filed on Dec. 20, 2005.
(60) Provisional application No. 60/751,546, filed on Dec. 20, 2005.
(60) Provisional application No. 60/833,004, filed on Jul. 25, 2006.

(51) Int. Cl. B01J 19/12

(52) U.S. Cl. 422/186.3

(57) ABSTRACT

Real time purification of contaminated common air is an unsolved public health problem inside residences and the workplace, and outside from air pollution by industry and transportation. Currently popular consumer grade electrostatic air filters accumulate suspended contaminants onto accumulation plates which require subsequent disposal or cleaning of the highly concentrated contaminates, a maintenance requirement that presents a new consumer health risk. Disclosed is a technology with several embodiments that structurally sequester and eradicate suspended particulates by electrostatically migrating them to an internal photocatalytic dismantling grid. The grid is a multicellular foundation of tetrafluoroethylene (Teflon) or Teflon-coated metal, with an outer layer of photocatalytic nanocrystals embedded in a durable, porous coating that is energized by ultraviolet radiation to create powerful surface dismantling agents thereon, including hydroxyl radicals, from natural elements in ambient air. Pathogens, mycotoxins, spores, odor molecules, allergens, smoke particles, and industrial pollutants are structurally dissociated into harmless protein fragments and natural molecules when they encounter the dismantling grid. The decontamination phenomenon is amplified by using the natural or enhanced positive or negative electrostatic surface charge on the suspended particles to migrate them to the dismantling grid for photocatalytic destruction. Contaminants, suspended water molecules, and trace ozone ions are drawn to the dismantling grid in this manner, also enhancing the supply of raw material from which the dismantling agents are created. The dismantling grid is self-cleaning and maintenance free, and is designed to use UV energy in a bandwidth that can physically inactivate pathogen replication defenses until photocatalytic destruction. Depending on the UV energy used, none of the powerful dismantling agents escape the apparatus because of their short half-lives. Once their job is done all return to the natural elements from which they were made, creating no environmental harm.

### BACKGROUND OF THE INVENTION

This application claims priority from provisional filing 60/751,547 “Airborne Virus Eradicator” filed Dec. 20, 2005, provisional filing 60/751,546 “Consumer Virus Eradicator” filed Dec. 20, 2005, and provisional filing 60/833,004 “Hydrogen Peroxide BioTower” filed Jul. 25, 2006.

This invention relates broadly to air cleaning devices that remove airborne contaminants of many types, including bacteria, fungi, spores, mycotoxins, viruses, allergen particles, odiferous molecules, volatile organic compounds, and other toxic industrial chemical effluents. This invention pertains to eradication of suspended contaminants in the air of enclosures which may still be occupied by people, plants and livestock; to the eradication of contaminants deposited on surfaces within a volume to be cleaned; and to the reduction of industrial airborne pollutants currently being exported to the environment.

There is a critical need to improve the air quality of inhabited areas by eliminating suspended contaminants. Sale of consumer air purifiers alone have risen dramatically worldwide since Sep. 11, 2001, because of civilian concern for epidemic pathogens (Avian Virus, SARS, Influenza), and their bio-engineered military grade counterparts (Plague, Smallpox).

Description of Conventional Filtration Untreated air contains a mixture of gases, water vapor, and particles. Odors are primarily caused by gaseous chemical molecules. Conventional adsorption filters rely on Van der Waal's forces, which is the attraction and capture of gas or liquid molecules to the surface of a solid. When the molecules come in contact with the boundary area of a solid, they are drawn to the surface and captured in macrospores and microspores. Since adsorption filters also attract moisture, most conventional applications stress the control of humidity in the areas where they are to be used. Otherwise the surface area of the adsorption media will become saturated with water vapor molecules and will be unable to remove gases and odors. Such absorption filters have varying degrees of effectiveness depending upon materials used, absorption area, etc. Generally, all require replacement and disposal on a scheduled basis.

A cubic foot of “clean” air will contain over a million particles; “dirty” air contains well over 30 million particles. Over 95% of the total weight of the particles in a cubic foot of air will be found in less than 1% of the total quantity of particles. Air particles between 10 and 1 microns in diameter will settle in still air, however, regular air currents can keep them airborne for substantial periods of time. (For size comparison, a human red blood cell is 7 microns in diameter.) Particles between 1 and 0.1 microns in diameter remain airborne in normal conditions, but will eventually settle in perfectly still air. Particles smaller than 0.1 microns behave like gas molecules and may remain airborne permanently.

Particles smaller than 2 microns are normally drawn into the lungs and may be retained there, so those particles cause the greatest concern to health professionals. Fungus debris and spores generally range from 20 microns down to 1 micron in size. Intact bacteria range from 40 microns down to 0.2 microns. For example, military grade Anthrax and Tuberculosis pathogens for airborne delivery range from 5 microns down to 1 micron in diameter. Viruses range from 0.3 microns down to 0.01 microns in size.1

Today's portable consumer air purifiers electrostatically attract contaminant particles to an accumulation plate that has a negative electrical charge. The process of creating ions with an electrostatic field naturally creates a small air movement. Marketers have seized on this silent air movement feature to promote a quiet, but marginally effective product. The accumulation plates become covered with highly concentrated contamination and must be periodically discarded or cleaned, presenting a new consumer health risk. Despite their popularity and claims for low energy consumption, such units aren't particularly effective air purifiers according to published consumer product testing laboratory reports.

### BRIEF SUMMARY OF THE INVENTION

The present invention provides a purification method and apparatus wherein contaminating particles suspended in breathable air are migrated to an eradication site within the apparatus where they are molecularly dismantled into harmless fragments. The powerful dismantling agents to carry out the purification are generated within the apparatus from available natural elements passing through it.

The apparatus separates and concentrates contaminants on a dismantling grid, then eradicates them by permanently dissociating them down to the molecular level. Depending upon the wavelength of the illuminating radiation, some of the powerful dismantling agents used in the eradication process will exit the apparatus to eradicate contaminants that have been deposited on treatment enclosure surfaces. Within a short period all dismantling agents return to the natural elements from which they were created once their job is done, without causing any harm to the environment.

Accordingly, it is a primary object of the present invention to provide a new and improved method and apparatus for destroying contaminants thereby.

It is a further object of this invention to improve breathable air and in so doing, use no ingredients and leave no residue that could be harmful to the environment.

It is a further object of this invention to destroy contaminants that have been deposited on surfaces within a treatment enclosure.

It is a further object of this invention to permit operation of the method and apparatus while people, pets, plants, or livestock may be present in the air being treated.

It is a further object of this invention to separate and migrate suspended contaminants to an eradication site within the apparatus, effectively amplifying its eradication effectiveness.

It is a further object of this invention to eradicate all migrated contaminants by structural dissociation of their cellular and chemical makeup, converting them to non-threatening forms, down to the level of natural, harmless environmental molecules.

It is a further object of this invention to immediately inactivate the replication capability of pathogenic contaminants until they can be destroyed within the apparatus.

It is a further object of this invention to amplify the dismantling effect itself by migrating ambient water molecules to a dismantling site to enhance the proximate raw material needed to enhance total photocatalytic activity.

It is a further object of this invention to provide several apparata embodiments for carrying out methods that achieve the foregoing objects and which are relatively simple in construction and effective in operation.

It is a further object of this invention to provide such methods and apparata that can easily be used in either a portable configuration by one person, or permanently incorporated into the conventional air handling systems of industrial and residential buildings.

It is a further object of this invention to provide such methods and apparata that can be permanently incorporated into the air handling systems of transportation vehicles such as aircraft, trains, and busses.

It is a further object of this invention to provide a method and apparatus that can be permanently incorporated into the air waste stream of industrial facilities and health care facilities in order to minimize toxic industrial chemical pollution and hazardous pathogen emissions to the environment.

### BRIEF DESCRIPTION OF THE DRAWINGS

FIG. 1 is a graphical plot showing the typical spectral emission lines of the type of plasma tube lamps used in this invention;

FIG. 2 is a table showing the comparative oxidation strength of the family of dismantling agents which includes those produced in the invention;

FIG. 3 is a diagram depicting the typical photocatalytic mechanism using semiconductor nanocrystals;

FIG. 4 is a diagrammatic cutaway of one embodiment of the invention in an apparatus whose inside lining and central lamp(s) have photocatalytic coatings that are activated by the UV energy present;

FIG. 5 is a graphical plot showing the reflectance of broadband UV energy by an uncoated highly specular reflective sheet, and the absorbance by multiple layers of a nanocrystal coating applied to the same reflective sheet;

FIG. 6 is an image of a UVB lamp with photocatalytic coating permanently applied to its outer surface, showing creation thereon of hydroxyl radicals oxidizing agent, confirmed by color conversion of an area where clear Nitroblue Tetrazolium solution was painted before UV illumination.

FIG. 7 is a graphical plot of the absorption spectra of ozone.

FIG. 8. is a graphical plot of the absorption spectra of hydrogen peroxide.

FIG. 9 shows measurement levels of hydrogen peroxide that are exported from the embodiment shown in FIG. 4.

FIG. 10 is a second embodiment wherein the suspended contaminants pass through single or multilayer porous, photocatalytic coated cylindrical dismantling grids which are sealed at the top, showing purified air, and depending on the lamp(s) used also ozone and hydrogen peroxide, exiting the top of the apparatus.

FIG. 11 is a third embodiment wherein the suspended contaminants, carrying either a natural on imposed electrical surface charge, are migrated to and held to an oppositely charged, multiple layer, photocatalytic coated, intermediate dismantling grid, showing purified air, and depending on the lamp(s) used also ozone plus hydrogen peroxide, exiting at the top of the apparatus.

FIG. 12 is a diagrammatic representation of the core of the FIGS. 10 and 11 embodiments, depicting adjacent decontamination grid cylinders arrayed such that larger volumes of contaminated air may pass through them for purification.

FIG. 13 is an illustration of the FIG. 12 array of dismantling grid cylinders packaged into the form of a modular, plug-and-play air decontamination cartridge for use in installed air handling systems of residences and commercial buildings.

### DETAILED DESCRIPTION OF THE INVENTION

UV Radiation Source The present invention uses electromagnetic energy in the 40 nm to 400 nm range. Plasma discharge tubes are used which contain selected gaseous chemical mixtures under precisely optimum pressures. Electrical voltage applied to the tube creates a conducting plasma of electrons and ions (atoms with either extra or missing electrons). The electric field in the plasma accelerates the electrons, which collide with the gas atoms, exciting them to upper energy states from which the atoms radiate, known as the photoelectric effect discovered by Einstein in 1917. The plasma continues to be an electrically conducting medium because the creation of new electron-ion pairs balances the rate at which they are lost by recombination. Electrical energy into the lamp is converted to ultraviolet radiation emanating from the lamp. Unlike glass walled fluorescent lamps, these have no internal fluorescent coating and all of the radiation passes through the special fused silica or quartz tubular side walls of the lamp and is available to react with target molecules outside the plasma lamp.

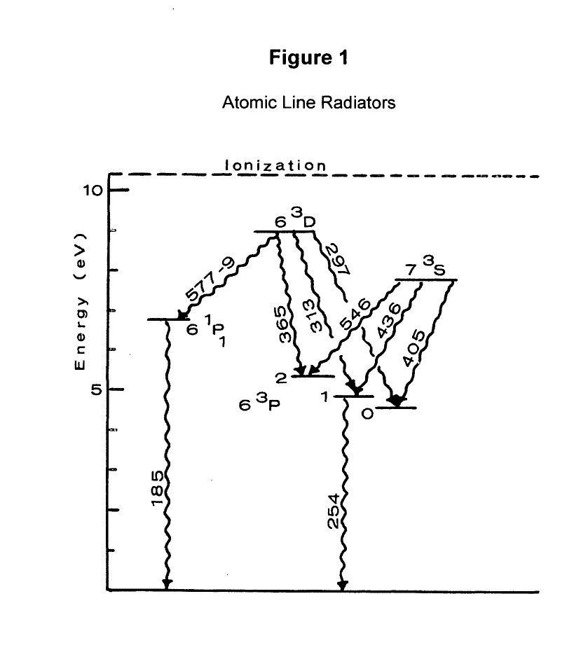

Low pressure (low energy requirement) mercury plasma lamps, known as atomic line radiators, emit two predominant wavelengths of ultraviolet radiation, one in the Vacuum Ultraviolet (“VUV”) range (40-200 nm) concentrated at 184.9 nm and one in the Ultraviolet C (UVC) range (200-280 nm) concentrated at 253.7 nm. See FIG. 1. The 254 nm energy is close to the 265 nm optimum absorption energy for inactivation of microorganisms. For exclusively germicidal applications the lamp walls are typically doped with material that absorbs the plasma VUV emissions, which if not absorbed would split ambient oxygen molecules and generate ozone (O₃). Sterilization by the use of such ultraviolet germicidal irradiation has been taught by several issued patents. All organic (carbon-based) material is photodegradable at some point within the 100 to 320 nm bandwidths and each organic compound has a characteristic sensitivity where peak chemical alteration will occur. Most organic materials have strong absorption bands between 200 nm and 320 nm. At those points the molecular structure of the organic starts to be altered as the short-wave UV irradiation energy begins to reduce the number of electrons orbiting in the molecule. The brief, high intensity exposure, alters the DNA or RNA of the microorganisms passing through the irradiation field by creating peptide bonds across the nucleic acid bases, preventing further replication of the pathogen. Most commercial applications have been for the disinfection of drinking water, to control mold growth in the coils of heating, ventilation and air conditioning (HVAC) systems, or to disinfect biological waste streams.

Dismantling Agents—Active Oxygen Species Within a reaction chamber filled with air and high concentration UV-VUV ionizing energy, a family of activated oxygen species will be generated. Each of these oxidants has different physical properties and energy level that make them particularly suitable to molecularly destroy, as described below, the cellular building blocks of odiferous molecules, allergenic particles, bacteria, mycotoxins, fungi, spores, and viruses. Once their dismantling job is done these powerful oxidizers have a bio-friendly conversion chemistry that causes them to quickly decompose themselves into harmless residues and pure natural elements, such as molecular oxygen, carbon dioxide, and water. The following activated oxygen species are produced in such a high flux reaction chamber:

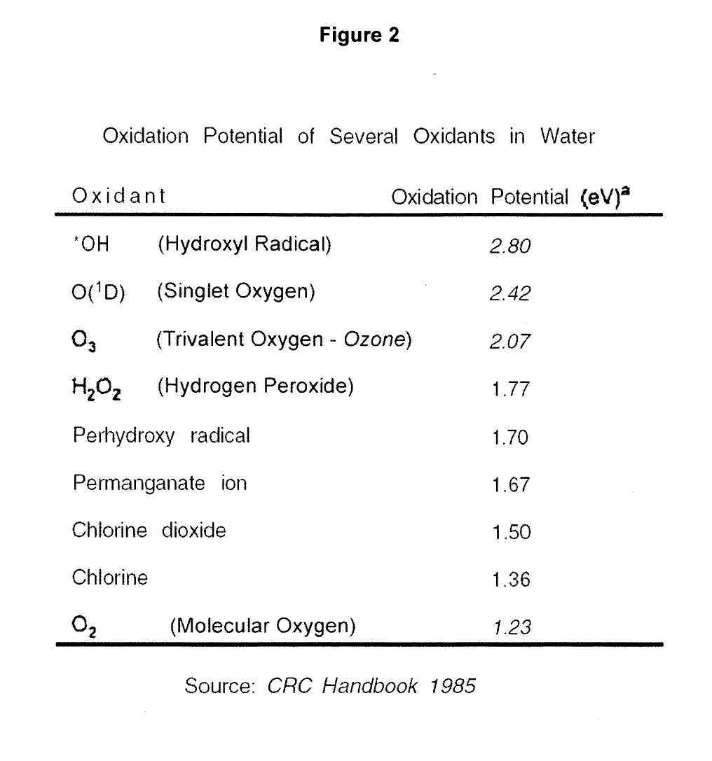

Singlet Oxygen is generated by UVC from ambient air within such a reaction chamber. Although molecular oxygen O₂ is highly stable, it has two unpaired electrons in its lowest energy state. The existence of unpaired valence electrons in a stable molecule is very rare in nature and confers high chemical reactivity. Energy transfer by UVC to O₂ or O₃ often results in the formation of Singlet Oxygen (¹O₂), which is essentially oxygen with extra energy. It is the first excited state of the O₂ molecule where electrons in the highest occupied molecular orbitals have been rearranged by the energy absorption. Two different forms of ¹O₂ are found. They are not free radicals and each has a different energy level and lifetime. Many exothermic chemical reactions generate ¹O₂ as a product. These are often chemiluminscent owing to the radiative decay of the ¹O₂. For example, many enzyme catalyzed reactions with peroxidases generate Singlet Oxygen luminescence. ¹O₂'s 1270 nm and 762 nm emission is the source of atmospheric airglow 40-180 miles above the earth's surface and is present in the atmospheres of Venus and Mars. Essentially, changes to the spin of O₂'s higher orbital electrons give the new Singlet Oxygen molecule a substantial reactivity toward electron rich organic molecules. The excited molecule is transient over fractions of a second and is extremely active chemically until it reacts with a target molecule. See FIG. 2.

¹O₂ is generated in biological systems in the defense mechanisms of phagocytic immune system cells against viruses and bacteria. The molecule has damaging effects on biomolecules and exerts genotoxic, virucidal and cytotoxic effects. Biological targets include fatty acids, proteins and DNA. All biological cell membranes are composed of phospholipid bilayers. Enclosing the exterior wall, these membranes regulate the flow of materials and information between the cell and its environment. ¹O₂ is a known cause of lipid peroxidation. The biomembranes are ruptured by Singlet Oxygen chemical reactions in conjunction with other active oxygen intermediates. These reactions propagate the initial damage via a chain reaction. Because of this Singlet Oxygen properties are being researched for use in photodynamic therapy as “magic bullets” to kill tumor cells. The EPA also recently sponsored successful research into the use of Singlet Oxygen to disinfect drinking water passing through tubes lined with a photoinitiated polymeric coating.

Superoxide Anion (O₂—) is the one electron reduction product of molecular oxygen and considered to be the active species that initiates a majority of oxidative chain reactions in most biological systems, including man. For example, the “oxidative burst” of activated neutrophils produces abundant superoxide ions, which is believed to be an essential factor in producing the cytotoxic effect of activated neutrophils. Superoxide is a Negative Ion (“Anion”) not a covalently based oxyradical. It has a very short life, and unless it comes in contact with organic material, it quickly disproportionates to form Hydrogen Peroxide (H2O2)

Photodynamic Production of Trivalent Oxygen Purified O₃, called Ozone, is produced within such a reaction chamber by the combination of Atomic Oxygen Radicals (generated by VUV radiation—see below) colliding with unsplit oxygen molecules. The new molecule structure has 3 oxygen atoms, but steric hindrance prevents it from forming a stable triangular structure which would have each O atom forming the expected 2 bonds. Instead each oxygen atom forms only 1 bond, with the remaining negative charge being spread throughout the molecule. Because of this, Ozone is a powerful oxidizer. Fluorine has about 50% more oxidizing power than Ozone, but Ozone is the most powerful oxidizer and disinfectant that can be safely used in pools and spas. See FIG. 2.

Free Radicals, called Oxyradicals are generated from moist ambient air passing through a reaction chamber containing a high flux of UV energy. These free radicals are active disinfectants, unstable chemical species with half lives of fractions of a second. The atomic forces in nature cause atoms to seek to share pairs of electrons. The bond formed by the sharing of a pair of electrons by two atoms is called covalent bonding. Depending upon the atoms involved the electrons in covalent bonds are not necessarily shared equally by the two atoms that they join together. If one atom has a greater tendency to attract electrons toward itself than the other, the electron distribution in the bond is called polarized and that atom's strong tendency to draw electrons into a covalent bond toward itself makes the atom strongly electronegative. Free radicals are chemical species that contain unpaired electrons. Free radicals relentlessly strive to reacquire a missing paired electron from any available target molecule. Because of this free radicals are often initiators that start a new chemical chain process.

Atomic Oxygen Radical (O₁). In the O₂ molecule the two oxygen atoms share two pairs of electrons, (there are four net bonding electrons), therefore O₂ has a double bond of paired electrons. (N₂ has a triple bond—six shared electrons.) Molecular oxygen absorbs photonic energy with a wavelength of less than 242 nm, (UVC and VUV), with a peak absorption at 190 nm. Within the reaction chamber intense VUV radiation at 184.9 nm is absorbed by the stable two-oxygen molecule _{O2}, breaking its molecular bond, resulting in two O₁ free radicals (Atomic Oxygen). A single atom O₁ of oxygen will immediately search for a stable molecular combination. Many of these Atomic Oxygen Radicals merge with molecular oxygen O₂ to form trivalent oxygen O₃, Ozone. Others react to form powerfull new free radicals within the reaction chamber.

Hydroperoxide Radical, (H0₂). Hydrogen ions (H+) produced by UVC irradiation of organic material react with atmospheric oxygen to form hydroperoxide radicals (H0₂). These react with more hydrogen ions to form Hydroperoxide ions (HO₂). The powerful chain reaction process propagates naturally to aggressively oxidize organic material and water vapor, and produces Hydroxyl Radicals from the hydrogen present.

Hydroxyl Radicals. Strong VUV ionizing radiation inside a reactor chamber is absorbed by water vapor molecules in the reactor airstream. Wavelengths shorter than 190 nm cause photolysis (dissociation) of the H₂O molecule to yield hydrogen radicals (H₁) and Hydroxyl Radicals (OH). Organic material is molecularly degraded by the powerful reducing species H₁, and the powerfully oxidizing species OH. The OH radicals are potent one-electron oxidants that steal hydrogen molecules from the organic material, leaving decayed carbon ions in their place. The theft of hydrogen from organic molecules by hydroxyl radicals forms even stronger OH bonds, with even higher oxidation, as a result of water vapor present. The process turns into a chain reaction . . . the breakdown and formation of new OH results in continual decay of the organic material into smaller and smaller molecular fragments. Hydroxyl radicals tend to target organic material for oxidation and not inorganics such as metals. The end result of the photochemical conversions is eventually water and decayed carbon based material so the eradication is essentially a bio-friendly green process.

The presence of water vapor works well in a UV based ozone generation system, but not in a coronal discharge (CD) ozone generation system. CD type ozone generators, regardless of size or output, will produce Oxides of Nitrogen as a natural and unavoidable by-product of their method of operation. The high voltage electron that is the power behind the CD process also causes some oxygen atoms to combine with Nitrogen, which comprises approximately 78% of the earth's atmosphere. When the oxides of Nitrogen come in contact with water, the result is the formation of a very weak concentration of Nitric acid, the concentration of which will increase as more NOX compounds are produced. The result is a slightly disagreeable odor which is associated with CD ozone systems detectable as a “Metallic” or “Electrical” sensation that will generate complaints. Nitric acid is also very corrosive to critical internal parts of a coronal discharge ozone generator, which can cause premature failure and increased maintenance frequency. Nitric acid production is minimized by drying the ambient air feeding the CD ozone generator. UV based ozone generators do not generate oxides of Nitrogen.

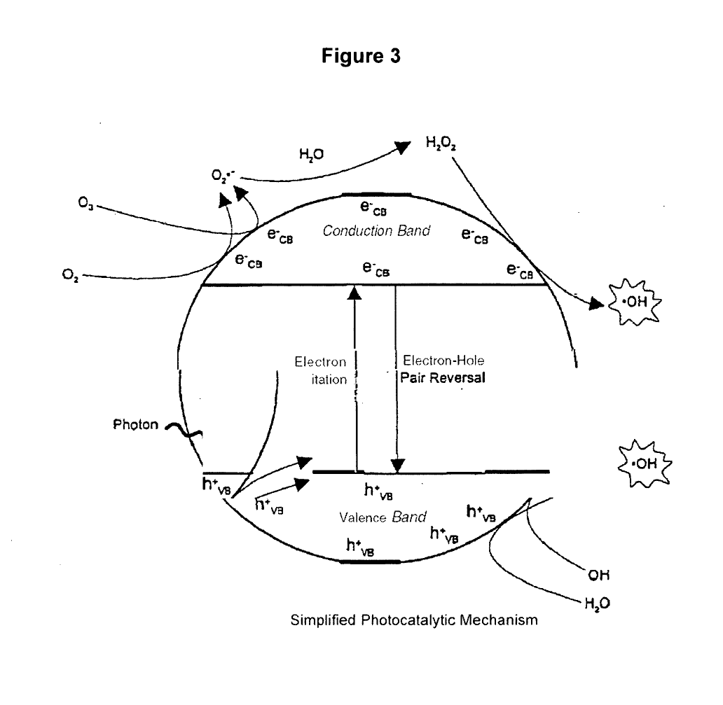

Surface Production of Hydroxyl Radicals Hydroxyl Radicals have the highest known thermodynamic oxidation potential at 2.80 (eV)2, higher than Singlet Oxygen of 2.42, Ozone of 2.07, and Hydrogen Peroxide of 1.77. See FIG. 2. The reactivity of all free radicals makes them susceptible to radical-radical termination and radical-surface extinction, so their efficacy as oxidizers inside or outside a reactor chamber depends upon their constant replenishment. Hydroxyl radicals can be constantly regenerated on the surface of certain semiconductor material. Semiconductors are solids that have electrical conductivities between those of conductors and those of insulators. Semiconductor materials are characterized by two separate energy bands: a low-energy valence band and a high-energy conduction band. Each band forms essentially a continuous spectrum of energy levels in which electrons can reside. But electrons cannot reside in the separation region between the energy bands called the band gap. There are several nanocrystal semiconductors with band gap energy greater than 3.0 electron volts when activated by ultraviolet radiation with wavelengths shorter than 387.5 nm. In these nanocrystals, an electron is excited from the low to the high energy band, which also creates a “hole” with a positive charge in the low energy band. The electrons and holes exist long enough to participate in chemical reactions at the semiconductor surface, which is called a photocatalytic mechanism. One such photocatalytic reaction is the dissociation of H₂O ambient humidity water molecules into OH hydroxyl radicals at the semiconductor surface. The water vapor is consumed, but cycled back to natural elements including more water vapor. The end result of this photochemical conversion is eventually water and harmless decayed carbon based material so that the structural dissociation is truly an ecological bio-friendly process. The aggregate photochemical process is shown in FIG. 3.

Dismantling Agent Production Via Flux Field The invention uses very high ultraviolet energy radiation to create a family of active oxidizing species, including hydrogen peroxide, to eradicate contaminants suspended in passing air and contaminants deposited on surfaces in a contaminated area to be treated.

When activated by ultraviolet radiation with wavelengths shorter than 387.5 nm the nanocrystal coating produces powerful dismantling hydroxyl radicals from ambient water molecules. The hydroxyl radicals rob target molecule electrons from hydrogen atoms in passing organic matter to restore their own covalent electrons lost to the energizing radiation. The immobilized matrix coating provides a stable, yet porous dry carrier structure to permanently suspend the nanocrystals while permitting target molecules to move freely in and out of the nanocrystal matrix. The dismantling surface process generally applies to both gaseous chemical molecules (organic and some inorganic) and to microorganic particles such as pathogens and their mycotoxins and spores.

Invention's Optimal Use of Illuminating Radiation The present invention conformally surrounds the illuminating UV energy source with its dismantling grid surface thereby maximizing the use of illuminating radiation from conventionally shaped cylindrical UV lamps.

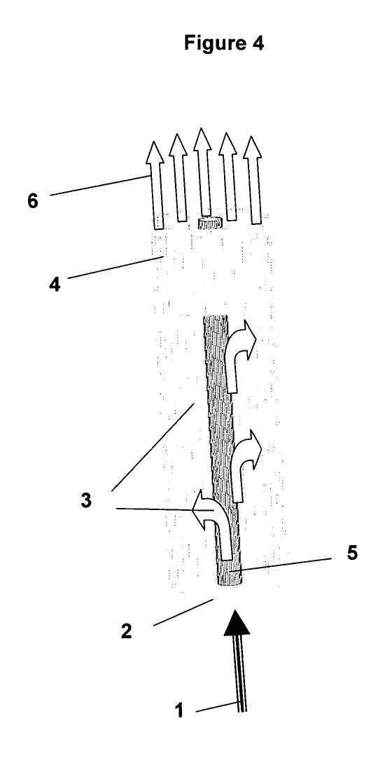

Cylinder With Dismantling Lining Cutaway FIG. 4 shows a coated cylinder embodiment of the invention. Contaminated air 1 is drawn into the bottom of the apparatus by a fan at 2. The flux of the UV energy radiation within the apparatus is intense, created by driving the plasma lamps at very high ballast currents and temperatures, and by the use of multiple UV lamps arrayed equidistant distant from one another within the chamber as 5. In our research six lamps together emitting the full UV range from VUV to UVA generate an extremely intense field that produces a high concentration oxy-species family including Singlet Oxygen, Superoxide, Atomic Oxygen Radicals, Hydroperoxide Radicals, and Hydroxyl Radicals. These effectively destroy virtually all suspended organic contaminants passing through the apparatus.

Experiments indicate that a single electrode-less microwave-energy-driven UV plasma lamp at 5 can raise the UV energy flux field to levels exceeding that of six conventional plasma tubes that are driven by electrical current to electrodes embedded in the tube walls. Such a microwave energy driven UV lamp can receive and convert substantially higher wattages of electrical input power into radiated photons with an indefinite service life and lower maintenance-replacement, since they do not suffer the limited longevity of electrode type lamps which are typically 8,000 to 12,000 operating hours.

The output wavelengths of plasma lamps used in the FIG. 4 embodiment are selectable. If only UVA, UVB or UVC lamps are used very little ozone is created. When VUV radiation is used, high levels of ozone are produced. Some of this ozone will survive the high energy flux field within the reaction chamber and be exported from the apparatus with the purified air. The apparatus of this embodiment generates high exportable O₃ levels of approximately 19,000 mg per hour concentration and high exportable levels of H₂O₂. (See below.) Ozone has a longer survival half-life than the other excited states of oxygen, so O₃ that reaches the exterior of the reaction chamber is available to carry out organic oxidation in remote areas. Ozone works by giving up its extra oxygen atom in an oxidation reaction. The collision between the ozone molecule and a molecule of oxidizable substance (i.e bacteria, fungi, viruses, iron, manganese, etc.) splits the weak bond and the oxygen atom changes the organic molecules; also, dissolved metals are made no longer soluble. Molecular oxygen O₂ is left as a by-product of the energy conversion.

The oxidation of organic matter by Ozone outside the chamber also generates a local cascade there of active chemical intermediates described above. While stealing loosely bonded electrons from carbon-based molecules it produces Singlet Oxygen, Atomic Oxygen, Hydroxyl Radicals, and Hydroperoxide Radicals during energy conversion. Each chemical species contributes a portion of the total oxidation effect taking place at the target molecule.

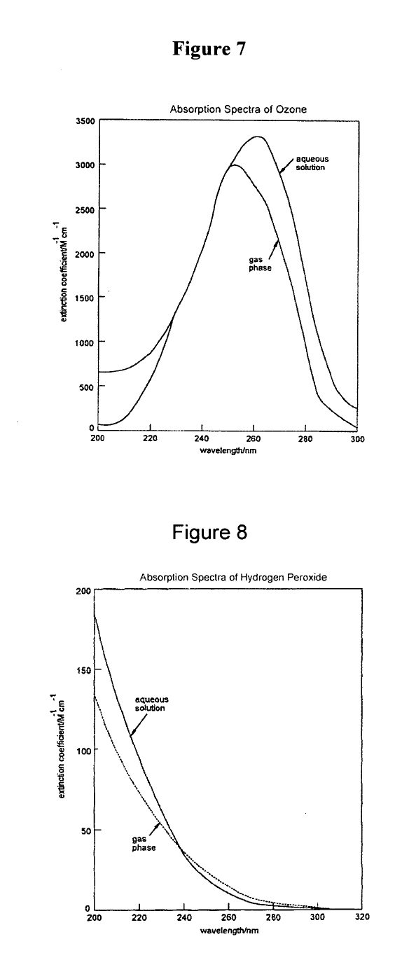

Much of the Ozone created in the apparatus reaction chamber is converted by the inter-radiation field into other active oxygen species before it can be exported. Ozone absorbs prodigious amounts of photonic energy in the 242 nm to 320 (UVC and UVB) range with a peak absorption line at 250 nm. (See FIG. 7—Absorption Spectra of Ozone.) This is a principal contribution to life on planet Earth. The solar UVB rays that Ozone absorbs in the stratosphere have enough energy to break chemical bonds in DNA, as described herein, and UVB interferes in other ways with biological processes.

Therefore, some Ozone produced in the apparatus reaction chamber absorbs the intense 254 nm energy field, and in the presence of moist air is converted to Singlet Oxygen, Free Radicals (Hydroxyl Radical, Superoxide Radical, and Hydroperoxide Radical), Hydrogen Peroxide (H₂O₂) and to molecular oxygen O₂ before it can exit the chamber.

### Ozone—Singlet Oxygen Reaction

O₃+hv→O₃+¹O₂
and
¹O₂+H₂O→2OH

Boosting Free Radical Production Hydrogen peroxide maximum absorption of UV radiation is at 200 nm so if the embodiment uses a high VUV energy field, low levels of exportable H₂O₂ would be expected. The prototype apparatus of this embodiment has an inlet port which can be used to infuse additional hydrogen peroxide to dramatically increase the production of Hydroxyl Radicals where a primary VUV apparatus is operating. Injected Hydrogen Peroxide is vaporized by the intense UV energy field as it enters the apparatus. The ionizing energy splits the hydrogen peroxide molecule directly into two Hydroxyl Radicals according to the adjacent photolysis reaction:
H₂O₂+hv→2OH

Hydrogen peroxide also reacts directly with Ozone in a “dark-based” (radiation free) homogeneous combination (called “Peroxone”) to produce Hydroxyl Radicals, molecular oxygen and Hydroperoxide Radicals. This reaction accelerates the decomposition of ozone in the chamber in favor of a higher concentration of faster-oxidation-rate Hydroxyl Radicals.

### Peroxone Reaction

O₃+H₂O₂→OH+O₂+HO₂

Some of the injected Hydrogen Peroxide plasma is dissociated by the Hydroxyl Radicals, in another dark-based reaction, into Hydroperoxide Radicals and water vapor. This contributes additional H₂O molecules to the generation of Hydroxyl Radicals by the photolysis of water molecules:
H₂O₂+OH→HO₂+H₂O

It has been shown experimentally that the addition of hydrogen peroxide does significantly improve the performance of such a photocatalytic system. We attribute this to the combined step-up in Hydroxyl Radical concentration from both direct dissociation and through the renewal of a non-organic source of hydrogen for these reactions through the generation of new water vapor.

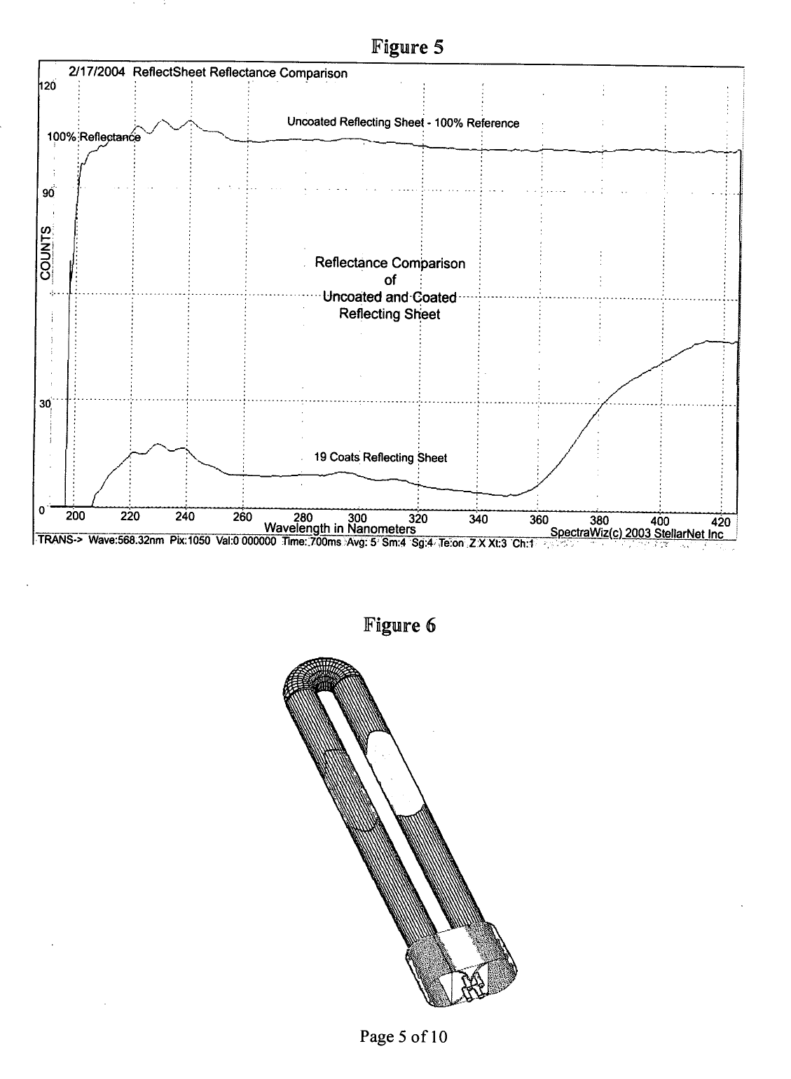

Dismantling Agents Produced On Photocatalytic Surfaces The apparatus of this embodiment also creates a family of decontaminating agents inside the device on photocatalytic coatings energized within the reactor by UVA, UVB, and UVC wavelength photons. Both the lamp 5 outer wall surface and the apparatus inner lining of wall 4 may have the nanocrystal embedded photocatalytic coating applied. FIG. 5 shows the absorption of UVA, UVB, and UVC energy by wall 4 when so coated.

The presence of hydroxyl radicals on nanocrystal semiconductor surfaces can be confirmed by the use of a clear, colorless chromophore, Nitroblue Tetrazolium (“NBT”). NBT is a chemical substrate used in medical research to measure the bacterial killing ability of human neutrophils, primarily whether they are producing phagocytic singlet oxygen ¹O₂, normally generated in such healthy white blood cells of the immune system. Singlet oxygen is a powerful, endogenous oxidant, second to hydroxyl radicals in its thermodynamic oxidation potential. Singlet oxygen, hydroxyl radicals, and hydrogen peroxide will reduce colorless NBT solution to an indigo dye-based chloride salt precipitate, thereafter displaying a deep blue visible color if they have been present to cause the reaction. FIG. 6 is an image of a UVB lamp with photocatalytic coating permanently applied to its outer surface, showing very high concentrations of surface hydroxyl radical oxidizing agents having been created, confirmed by color conversion of an area where clear Nitroblue Tetrazolium solution was painted on the photocatalytic coated lamp surface before UV illumination.

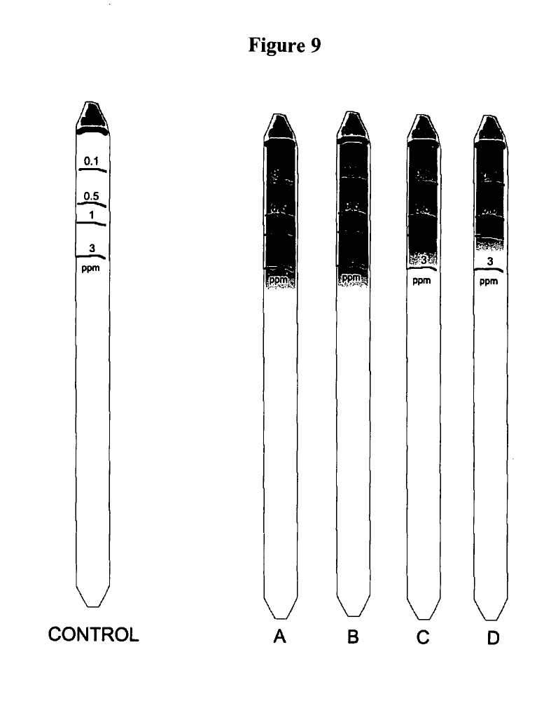

Hydrogen Peroxide Production Even with VUV energy present the supplemental H₂O₂ produced on the photocatalytic surfaces, and by the energy flux field, is not fully dissociated. Levels of H₂O₂ exported from the apparatus of this embodiment have also been measured with a Drager H₂O₂ tube sensor. See FIG. 9. The monitor takes twenty samples over a period of 3 minutes, reporting non-cross reacting H₂O₂ levels colormetrically in a range from 0.1 to 3.0 parts per million (PPM). The principle of measurement is:
2 H₂O₂+2 KI→I₂+2 H₂O+O₂, and one PPM of H₂O₂=1.4 mg H₂O₂/m³

Sample A, FIG. 9, taken at the export mouth of this embodiment with six electrode-type VUV-UVC plasma lamps, reached 3 PPM saturation in 10 seconds. Sample B was taken at 15 feet from the apparatus after 10 minutes operation in a 5,600 cubic feet enclosed volume, and reached 3 PPM saturation in 3 minutes. Sample C was taken at 20 feet from the apparatus in 20 minutes and reached 3 PPM saturation in 3 minutes. Sample D was taken 10 minutes after apparatus shutdown and reached 1 PPM in 3 minutes. Research also indicates that all ambient moisture passing through the apparatus that does not get converted to hydroxyl radicals or H₂O₂ on photocatalytic dismantling surfaces, is oxidized instead into H₂O₂ by active oxygen species in the chamber plasma, contributing further to the total export of that agent.

This embodiment is particularly effective in odor removal testing. We believe that this is partly due to the propensity for high export levels of O₃ and H₂O₂ to physically dislodge target material from contaminated surfaces, (for example: vehicle condensers, seats, liners, and floors), thereafter eradicating the dislodged, now-suspended organic contaminants as they pass through the intense dismantling plasma and impact the dismantling surfaces within the apparatus.

Carried by the moving air 3 shown in FIG. 4, the suspended contaminants impact either the photocatalytic coated surface of the central lamp(s) 5, or the inside dismantling liner wall 4 of the apparatus. At these photocatalytic coated surfaces ambient water vapor is being converted to a surface field of hydroxyl radicals by radiation from the central UV electromagnetic energy source 5. The constantly replenished surface free radicals structurally dissociate the impacting contaminants into smaller and smaller fragments, eventually to natural stable molecules and harmless protein fragments. If lamp 5 radiates UV energy in the wavelengths of UVA (315-400 nm), UVB (280-315 nm), or UVC (200-280 nm) purified air 6 exits the apparatus. If lamp 5 also radiates energy in the VUV range (wavelengths of 40-200 nm) both ozone O₃ and vapor phase hydrogen peroxide H₂O₂ are also exported from the apparatus together with purified air.

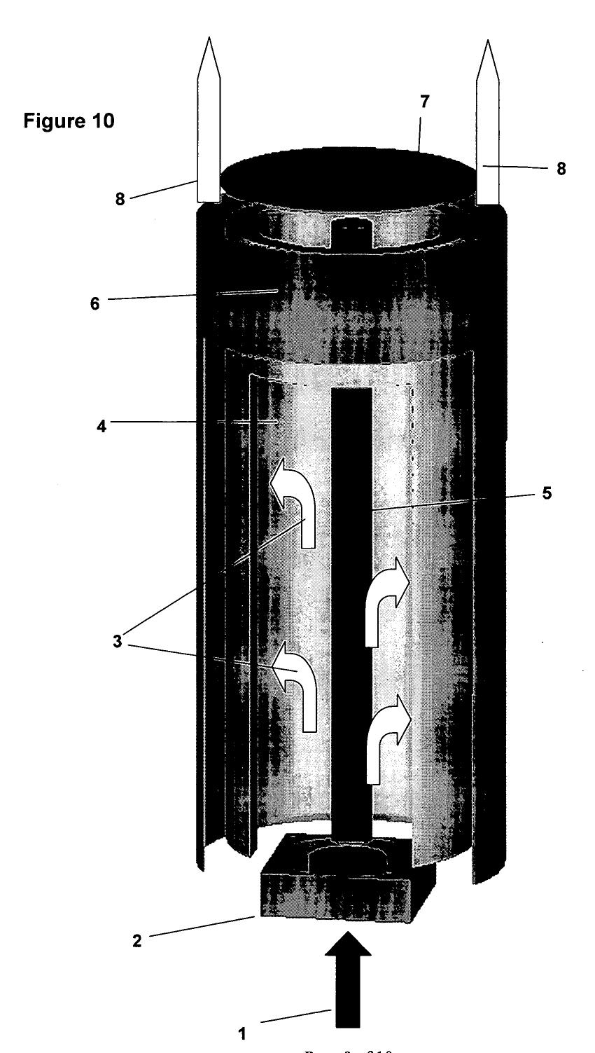

Intermediate Dismantling Grid Cutaway FIG. 10 shows a further embodiment of the invention. Contaminated air 1 is drawn into the bottom of the apparatus by a fan at 2. The contaminated moving air 3 must pass through a porous dismantling grid 4 that encircles the illuminating lamp(s) 5. In this embodiment the exposed wall of the porous dismantling grid 4 is conformally molded to be parallel to the curved wall of the light source 5, so as to provide an optimum direct light path to the maximum amount of photocatalytic coating on the dismantling grid surface. In this embodiment the dismantling grid may be a cylindrical screen or a flexible honeycomb cylinder. Honeycomb maximizes dismantling area exposed to direct UV radiation, yielding an efficiency improvement over approaches that present flat grids at lower efficiency angles to the light source. The light source 5 may be multiple lamps and electrode type or microwave driven lamps. Contaminants passing through the three dimensional porous dismantling grid 4, with its large active dismantling surface, are structurally dissociated into molecular fragments by the surface free radicals generated on the photocatalytic coating on 4 or on the surface of the UV lamps 5.

Intermediate dismantling grid 4 may be composed of virtually any inorganic material that can serve as a reliable porous structural foundation for the photocatalytic coating. The embodiment of FIG. 10 shows dismantling grid 4 composed of either an extruded or expanded tetrafluoroethylene (trade name Teflon) mesh or honeycomb cylinder, or a flexible aluminum mesh or honeycomb cylinder. Both have unique advantages. Teflon's transmissivity to the activating UV bandwidth, its extreme inertness to chemicals, its low coefficient of friction, its ability to resist adhesion to almost any material, and its ability to withstand extremely high operating temperatures (thousands of degrees Celsius), render it generally ideal for applications involving treatment of corrosive, dismantling, or combustible air flows. It retains high transmissivity to UVA, UVB, UVC and VUV, even after bonding of a photocatalytic nanocrystal coating. Therefore, multiple coated Teflon porous dismantling grids can be in the form of adjacent mesh planes, or as cylinders nested within one another, even placed conformally adjacent to a coated flexible honeycomb intermediate dismantling grid of different material (such as a ceramic). A coated flexible aluminum honeycomb cylinder grid dramatically increases the total photocatalytic surface area exposed to activating radiation. UV photons are emitted from lamp(s) 5 in straight lines at all angles. Since the honeycomb cells of proper cell volume and depth are radially arrayed facing the curved lamp outer wall, photons emitted at any angle from the lamp wall will travel directly into each honeycomb cell to impact photocatalytic coating on the inside of each cell wall, if the cell isn't too deep. In this way, UV light from 5 projects onto or through the coated multiple grid walls of 4, activating them as it passes, subsequently colliding with the inside of apparatus wall 6. The inside surface of 6 may be constructed of highly specular material, which reflects UV energy back onto the dismantling grid(s) 4, further amplifying total photocatalytic activation there. In the alternative, the inner surface of 6 may also be coated with the photocatalytic nanocrystal coating to provide additional dismantling surface area there. Disk 7 placed at the top of cylindrical dismantling grid(s) 4 forces air and suspended contaminants to pass axially through the dismantling grid(s). After passing through dismantling grid(s) 4 and being physically redirected longitudinally by outer wall 6, purified air 8, and depending upon the type of lamp 5 used also ozone and hydrogen peroxide, exit the apparatus.

Block Pathogen Replication Inclusion of germicidal radiation in the apparatus empowers it to render pathogenic contaminants unable to further replicate if they should exit the apparatus before destruction on the first pass. Replication is a typical defensive mechanism when pathogen survival is jeopardized. Our research shows that ultraviolet radiation in the 250-270 nm range is very suitable for producing the dismantling surfaces photocatalytic mechanism. FIG. 5 illustrates this, showing 85% -90% absorption of the UV energy between 230 nm and 370 nm by 19 thin layers of photocatalytic nanocrystal coating on a specular aluminum sheet. Germicidal effectiveness is based upon UV intensity over time because each microorganism must absorb a specific amount of energy to be destroyed. Intensity is measured in microwatts per square centimeter (uw/cm2). Time is measured in seconds. The embodiment of FIG. 10 generates an estimated 100,000 uw-sec/cm² of 253.7 nm UV radiation on a microorganism during its typical 4 second pass through the reaction chamber. This intensity is at an average maximum path length of only 6 cm (0.06 meter) from the lamp wall with six UVC lamps, which compares very favorably to standard tables using data accumulated by other scientists at a distance of 1 meter.

Charge And Migrate Contaminants Still yet another embodiment uses a process analogous to Free-Flow Electrophoeresis to separate contaminant particles from the moving air stream, migrating them to the activated dismantling grid where they are held for photocatalytic eradication. This increases “eradication dwell time”, raising the efficiency of the apparatus. The natural electrostatic charge of contaminants is used and even strengthened in this embodiment.

Most suspended contaminants have a natural electrostatic charge present on them. Large macromolecules generally have a natural positive charge. For example, tobacco smoke particles, odors and many allergens tend to be positively charged, which helps keep these large particles suspended in air. Small microorganism particles typically have a negative charge on them. Bacteria and their fragments are negatively charged due to their cell wall chemistry. Gram negative bacteria contain negatively charged —COO* groups associated with proteins and lipopolysaccharides in their cell walls. Gram-negative bacterial endotoxins (pyrogens) are also negatively charged as are viruses and most colloids.³ The ability to instead place or alter an electrostatic charge on a suspended particle is directly related to its total surface area and its total mass. It is more difficult to alter or increase the natural electrostatic charge on a small contaminant particle than on a large particle.

Consumer electrostatic air purifiers tend to use the natural positive charge that large particles and molecules possess to attract them to a negatively charged collector plate. This negative collector generally minimizes the production of ozone by the devices, the airborne concentration of which is regulated by governmental agencies because of its oxidizing toxicity to human lung material (as well as to pathogens). Such consumer devices are inherently less effective at removing smaller bacteria and viruses, which are inherently negatively charged.

Electrostatic technology itself is fundamentally sound, and a mainstay of industrial effluent abatement. Very large, expensive, constantly maintained industrial systems are in use worldwide at industrial plants. These industrial systems generally use positively charged collector plates. They first increase the electronegativity of the generally large effluent particles by strong field ionization, then migrate the particles to large, parallel, positively charged collector plates, which are physically cleaned by vibration. By product ozone generated in the process is exhausted to the environment.

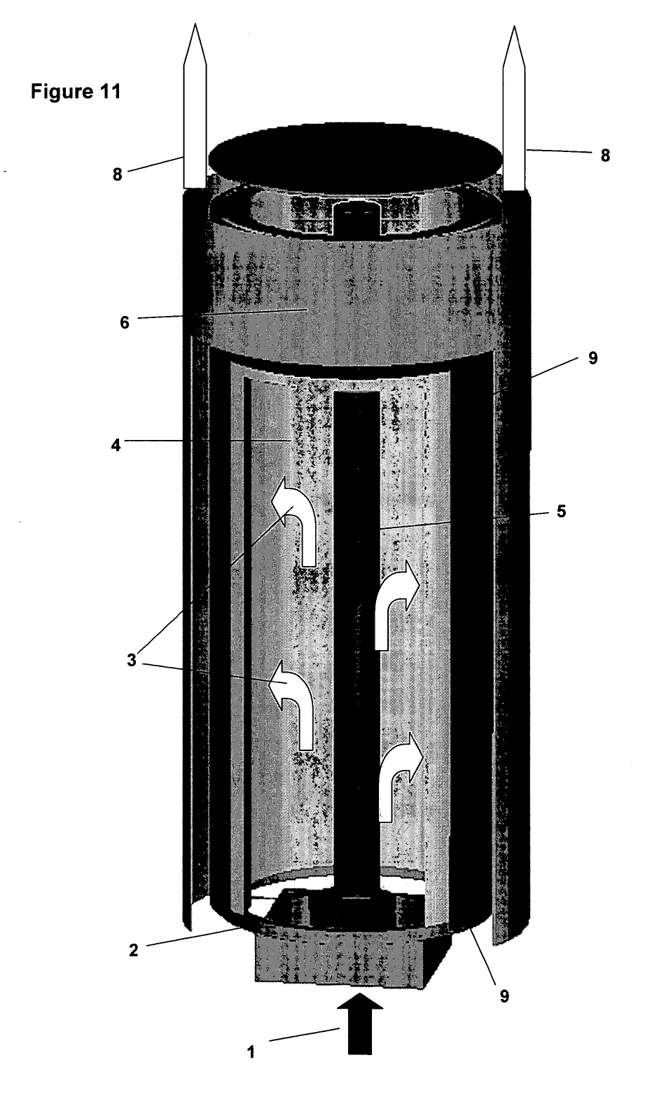

FIG. 11 shows an embodiment of the invention that enhances migration to, and retention of the contaminants on, the dismantling grid(s). Contaminated air 1 is drawn into the bottom of the apparatus by a fan. Carried by the moving air, the naturally charged contaminants 3 are migrated toward and retained on the electrostatically opposite charged dismantling grid 4. In order to carry an electrical charge, dismantling grid 4 will ideally be composed of a current carrying metal, such as aluminum or stainless steel. The photocatalytic coating applied to grid 4 must be dielectrically insulated from its metal foundation. Otherwise the surface field of dismantling free radicals on the photocatalytic grid walls would self-quench via electrical charging of the embedded nanocrystals toward either polarity.

The underlying current carrying metal dismantling grid may be charged with a low DC voltage (0-10 volts) or a high DC voltage (3,000 to 30,000 volts). This electrostatic potential will act through a tetrafluoroethylene (Teflon) dielectric coating and the photocatalytic nanocrystal coating on top of the Teflon, to attract contaminant particles with an opposite natural surface charge to the photocatalytic surface. If small, negatively charged pathogens are being attracted, the dismantling grid will need a positive charge. If larger, smoke-type particles or large allergens are being collected for eradication, the grid needs a negative charge. In this embodiment the charge on the dismantling grid can be switched to have either a negative DC charge, or a positive DC charge. Selection of the dismantling grid charge between positive or negative allows for flexible use of the apparatus for different contaminant environments. Automatic cycling between the two polarities with a user selectable electronic switching period, also permits the dismantling grid to be self-cleaning, since the switched field (of auto-selectable temporary strength) forces any accumulated, uneradicated clumps of oppositely charged contaminants off the grid temporarily, for eradication on a future pass.

In this embodiment the natural surface charge of contaminants entering the apparatus can be strengthened or even altered by inclusion of an ion generator 2. In this embodiment the component is a radially arrayed plurality of sharply pointed needle electrodes with a central metallic ground plane disk, sufficiently proximate to the needles that a corona is produced without causing arching across the air gap. The proximate ground plane for this ionizing field must have a radius of curvature that is orders of magnitude greater than the needle electrode radii. DC voltage in the lower end of the range (+or −) 3,000 to (+or −) 30,000 volts applied at very low current to the two electrode groups is adequate for ionization without significant ozone production. Electrons or ions “boil off” from the needles and by diffusion collide with, or may attach to, suspended contaminants passing through the interelectrode space, further strengthening or even reversing their natural net electropositive or electronegative surface charge. All the current in the interelectrode space is carried by the resulting ions.

Ambient water ions, ozone ions, and charged contaminants 3 are transported toward the oppositely charged attraction grid 4 by the combined influences of the electric field strength between 2 and 4 and the interaction of the charged particles 3 with the turbulent air flow designed into the apparatus. The interelectrode space is also filled with the high intensity UV field. Any ozone molecules present are subject to photolysis (particularly in the UVC range) that produces temporary singlet oxygen, which in turn may react with a water molecule to yield more dismantling hydroxyl radicals .OH. ⁴ (See FIG. 8—Absorption Spectra of Hydrogen Peroxide.)

The natural positive charge of larger particles and macromolecules can be reversed to net electro negativity by charging them with electrons produced in a negative corona discharge. A negative corona is created via a negatively charged ion generator in the contaminated airstream. The generation mechanism of the negative corona is different from a positive corona. With the negative electrode at high voltage potential, electrons formed by chance ionizing events gain energy from the electric field and produce ions and other electrons by collision. The positive ions are accelerated to the cathode where they bombard the electrode surface and, as a result, electrons are released from the surface. The electrons move into the weaker electric field away from the cathode where they collide with contaminant particles and chemical molecules, as well as with neutral gas molecules to form negative ions. The discharge is dependent on the surface of the electrode for electrons, so the discharge occurs in small regions, or tufts, instead of in a uniform bluish glow characteristic of a positive discharge. This negative discharge is more stable, and can achieve higher voltages and currents than a positive corona before sparkover.

The gasses N₂, CO₂, and H₂ have a much higher ionization potential than O₂ or ambient H₂O. The first three gasses tend to form positive ions in a positive corona, and (in a pure state) will not form negative ions by electron attachment. Therefore, electrons produced in a negative corona are more likely to form negative ions from O₂ and H₂O and to be available for attachment to large, positively charged contaminant particles to create on them a net electro-negativity. This abundance of electrons in the corona is also more likely to dissociate passing O₂ molecule into its two atoms, generating higher transient ozone levels than would be created in a positive corona. Ozone production levels are dependent upon several variables, including the field strength used and the interelectrode distance. This embodiment uses high levels of UVC which dissociate Ozone rapidly, See FIG. 7. Water molecules are strongly polar with a heavy oxygen atom and two light hydrogen atoms that are constantly exchanged between water molecules. Ionization produces separate ions of H⁺ and OH⁻ which quickly form hydronium ions H₃O⁺ and hydroxyl ions OH⁻, an intermediate for hydroxyl radical .OH formation at the dismantling grid(s).⁵

An alternative feature of this embodiment is the periodic reversal of voltages on the ion generator 2 and the attracting grid 4, either switched occasionally, or programmed to reverse automatically on a scheduled cycle. This feature will keep the attracting grid clean, and will alternately eradicate larger particles, such as tobacco smoke, that may normally carry an inherent positive charge, rather than the negative charge typical of pathogens. The free radical surface cloud on the dismantling grid doesn't care whether the contaminants it encounters are negative, positive, or electroneutral—it will dismantle all of them, indiscriminately.

Although most of the negative ions in the particle charging field are either attached to passing contaminants or are consumed by the attracting screen's opposite polarity, those that do escape the apparatus with purified air 8 generally freshen the escaping, breathable air and have a beneficial psychological effect on people who inhale them.

After contaminated air passes axially through the dismantling grid 4 and is redirected longitudinally by outer wall 6, purified air 8, and depending upon the type of lamp(s) 5 used, also ozone and hydrogen peroxide, exit the apparatus.

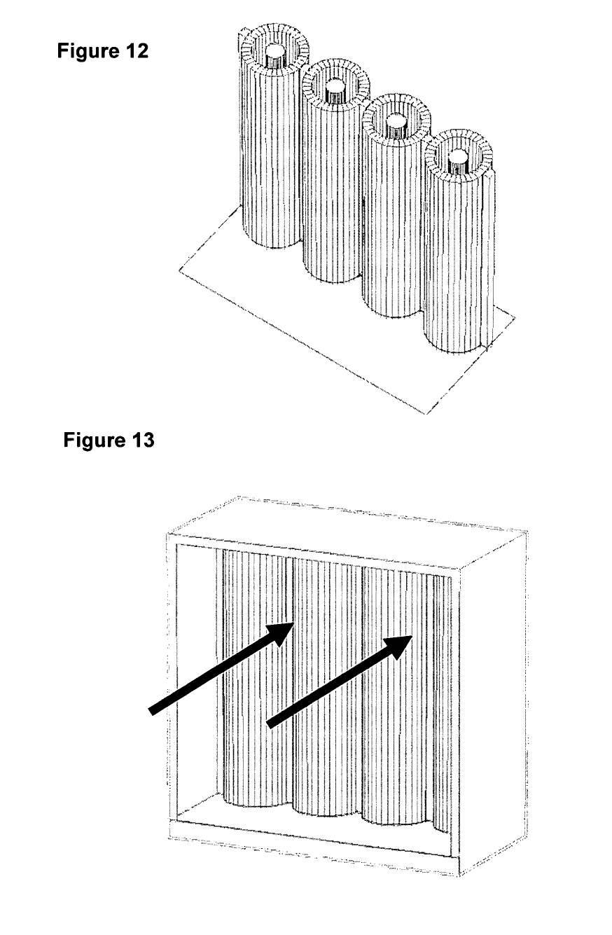

Arrays of Cylinders—In line Air Purification FIG. 12 shows a further embodiment of the invention in FIGS. 4, 10 and 11, whereby multiple porous cylindrical dismantling grids enclosing central activating lamps are joined tangentially to one another to present an array of efficient three dimensional dismantling surfaces to the contaminated air stream. FIG. 13 depicts an embodiment of the joined array of FIG. 12 configured into a cartridge box enclosure for insertion into the duct of an in-line air handling system, purifying contaminated air of built-in HVAC duct systems of residential and commercial buildings.

What is claimed is:

1. An air purifier comprising a chamber having an inlet and an outlet, an internal ultraviolet high energy field disposed in the chamber, photocatalytic coated internal surfaces in said chamber wherein to generate a family of short-lived active oxygen species that do not escape the chamber, and exportable vapor phase hydrogen peroxide that does escape the chamber.

2. The purifier of claim 1 for destroying, via structural dismantling organic or inorganic contaminants suspended in air passing through the apparatus.

3. The purifier of claim 1 for destroying, via structural dismantling with exported hydrogen peroxide outside the apparatus, organic, and inorganic contaminants, including malodor sources, that have been deposited on surfaces to be treated outside the apparatus.

4. The purifier of claim 1 wherein the energizing ultraviolet radiation wavelength ranges are a single lamp, or a collection of several lamps together of differing ultraviolet output ranges Vacuum-UV, UV-C, UV-B, UV-A, or combinations thereof to provide the intense energy flux field within the apparatus.

5. The purifier of claim 1, wherein a single (or multiple) electrode-less microwave energy driven UV plasma lamp is used to significantly increase the internal UV energy flux field, replacing multiple conventional plasma lamps that are driven by electrical current to electrodes embedded in the tube walls.

6. The purifier of claim 1 wherein the photocatalytic coated internal surfaces are the lamp walls, the inner wall of the apparatus, and/or one or more coated dismantling grids intermediate between the lamps and the apparatus inner wall.

7. The purifier of claim 1, wherein the only chemical raw materials used to produce the dismantling agents are natural elements contained in the ambient air passing through the apparatus.

8. The purifier of claim 1 wherein the level of the active oxygen species family created inside the apparatus may be increased during the treatment process by supplementing the ambient air passing through it with additional feed gas, such as hydrogen peroxide mist from an outside storage tank.

9. The purifier of claim 1, further comprising a dismantling grid constructed of extruded or expanded mesh formed from tetrafluoroethylene, (trade name Teflon), in the form of a plane, cylinder, or other geometric shape, with a photocatalytic nanocrystal over-coating applied to its surface.

10. The purifier of claim 1, further comprising a dismantling grid constructed of extruded or expanded mesh formed from a current carrying metal such as, aluminum, copper, tungsten, nickelized steel, or other metal, in the form of a plane, cylinder, or other geometric shape, with a photocatalytic nanocrystal over-coating applied to its surface.

11. The purifier of claim 1, further comprising a dismantling grid constructed of flexible honeycomb material to increase the overall photocatalytic surface area available for dismantling.

12. The purifier of claim 1, further comprising an energizing light source, wherein the longitudinal placement of the energizing light source in the apparatus and the conformal shaping of the dismantling grid around it, permit the UV photon emission paths to radiate directly onto the maximum exposed dismantling area of the grid for maximum dismantling effectiveness within the apparatus.

13. The purifier of claim 1, further comprising multiple coated Teflon porous dismantling grids, said grids in the form of adjacent mesh planes, or cylinders nested within one another because of their UV transmissivity, even placed conformally adjacent to another intermediate coated flexible honeycomb or mesh dismantling grid of different, non-UV transmissive material.

14. The purifier of claim 1, wherein contaminants entering the apparatus with a natural surface charge are migrated to, and retained on, a dismantling grid with an opposite electrostatic charge, to enhance “dwell time” for photocatalytic dissociation and molecular eradication.

15. The purifier of claim 1, further comprising an electrostatic attraction screen, wherein the current carrying metal electrostatic attraction screen is coated with a durable, UV transmissive diaelectric such as tetrafluoroethylene (Teflon), which is further over-bonded with a photocatalytic nanocrystal coating.

16. The purifier of claim 1, wherein contaminants, and ambient water vapor molecules, suspended in the air entering the unit are electrically excited by a strong voltage flux field that creates, or amplifies, a net electronegative charge (or a net electropositive charge) on either type of suspended particles by the production and binding of field produced electrons, negative ions, and/or positive ions to the suspended particles.

17. The purifier of claim 1, wherein any ozone produced in the interelectrode space of the inlet ionizing field become charged ozone ions in the air stream and attracted to the oppositely charged dismantling grid.

18. The purifier of claim 1, wherein use of the 240-280 nm range of UV radiation is readily absorbed by the photocatalytic coating on the photocatalytic surfaces, triggering surface creation of dismantling oxygen species, accelerating the natural depletion of any ozone ions in the air stream back to oxygen, and blocking defensive reproduction of passing pathogens (before they can be structurally dissociated in the apparatus) by creating unnatural peptide bonds across their deoxyribonucleic acid base pairs.

19. The purifier of claim 1, wherein the voltages placed on the dismantling grid, or if used the ion field generator, are reversed at time intervals, either selectively or automatically, in order to enhance capture of oppositely charged contaminants, and to clean the attraction-dismantling screen by electrically repelling clumped charged debris that may be temporarily coating it.

20. The purifier of claim 1 using only UVA, UVB, and/or UVC energy with arrays of cylindrical or planar dismantling grids packaged for insertion into an in-line air handling system for continuous purification of breathable air.
